(19) United States
(12) Patent Application Publication
(10) Pub. No.: US 2007/0178936 A1
(43) Pub. Date: Aug. 2, 2007

(54) Hand-held portable device with wireless data transfer module

(76) Inventor: Kuo Ching Chiang, Linkou Township (TW)

Correspondence Address: BIRCH STEWART KOLASCH & BIRCH, PO BOX 747, FALLS CHURCH, VA, 22040-0747, US

(21) Appl. No.: 11/707,017

(22) Filed: Feb. 16, 2007

Related U.S. Application Data
(63) Continuation-in-part of application No. 11/021,270, filed on Dec. 23, 2004.

(51) Int. Cl. H04M 1/00; H04B 1/38

(52) U.S. Cl. 455/557; 455/556.1

(57) ABSTRACT

The portable device comprises a processing unit embedded in the portable device and a RF module coupled to the processing unit for communication. A display and an input unit are coupled to the processing unit. A non-volatile memory is coupled to the processing unit to store data; and a computer data exchanging interface is provided. The device further comprises a wireless transmission module coupled to the IC for video or audio file transmission from an external device.

The application is a CIP (continuous-in-part) application of United States Patent Application 20060143339, filed on Dec. 23, 2004.

### FIELD OF THE INVENTION

The present invention relates generally to a portable terminal and more particularly to a hand held portable device with wireless transfer module.

### BACKGROUND OF THE INVENTION

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone. The cellular manufactures have to release new models with different appearances, function and styles more frequently so as to attract the attention of the buyer and occupy a favorable marketing share.

### SUMMARY OF THE INVENTION

An object of the present invention is to provide a portable device with wireless transmission module for transferring audio/video file with an external device.

The portable device comprises a processing unit embedded in the portable device and a transmission module coupled to the processing unit for wireless communication. A display and an input unit are coupled to the processing unit. A non-volatile memory is coupled to the processing unit to store data; and a USB interface is coupled to the processing unit, whereby the USB may couple to a device through the USB interface such that the portable device functions as flash drive. A memory capacity detecting module is coupled to the processing unit to detect the capacity of the non-volatile memory, followed by displaying on the display. A pointer assembly is coupled to the processing unit. The pointer includes a trackball or a joy stick. In alternative preferred embodiment, the portable device comprises a processing unit embedded in the portable device and a RF module coupled to the processing unit for communication. A display and an input unit are coupled to the processing unit. A non-volatile memory is coupled to the processing unit to store data; and a computer data exchanging interface is provided. The device further comprises a wireless transmission module coupled to the IC for video or audio file transmission from an external device.

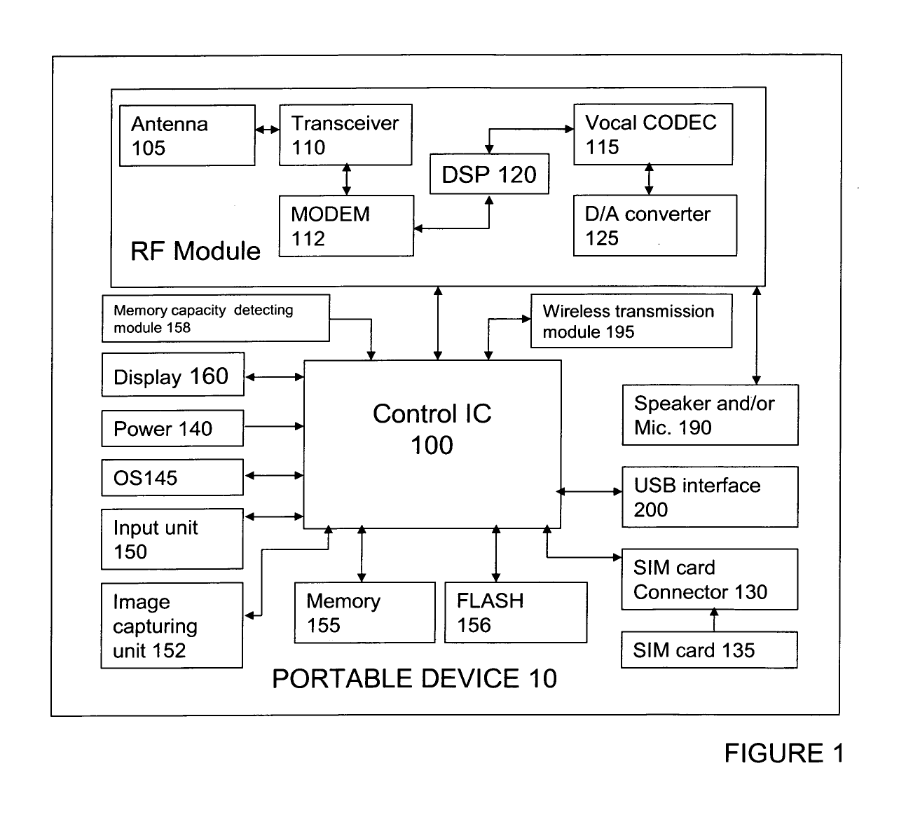

FIG. 1 shows a diagram of a portable terminal according to the present invention.

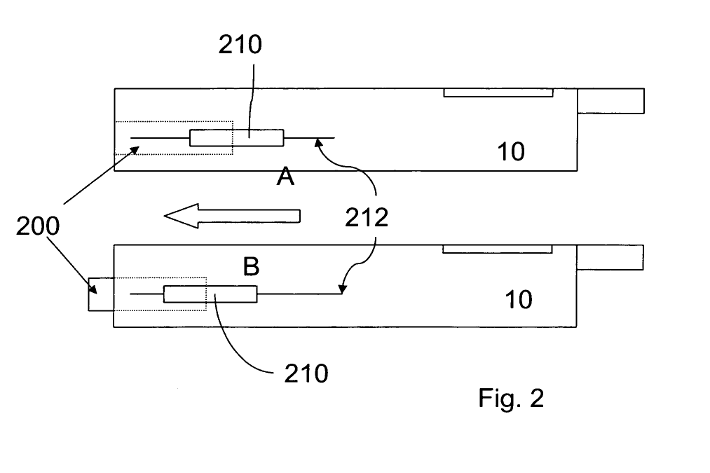

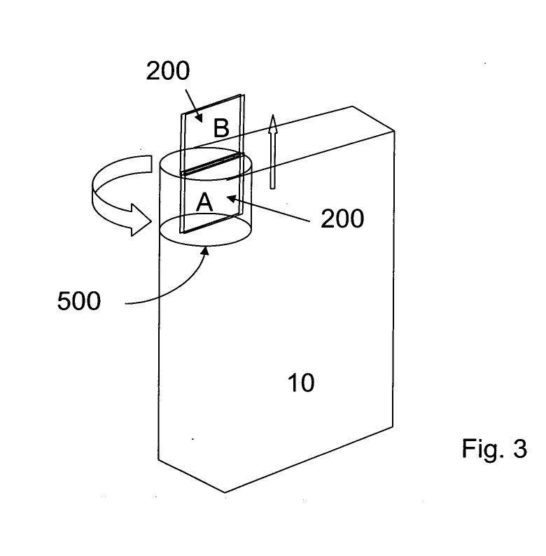

FIG. 2-3 show a diagram of an interface releasing unit according to the present invention.

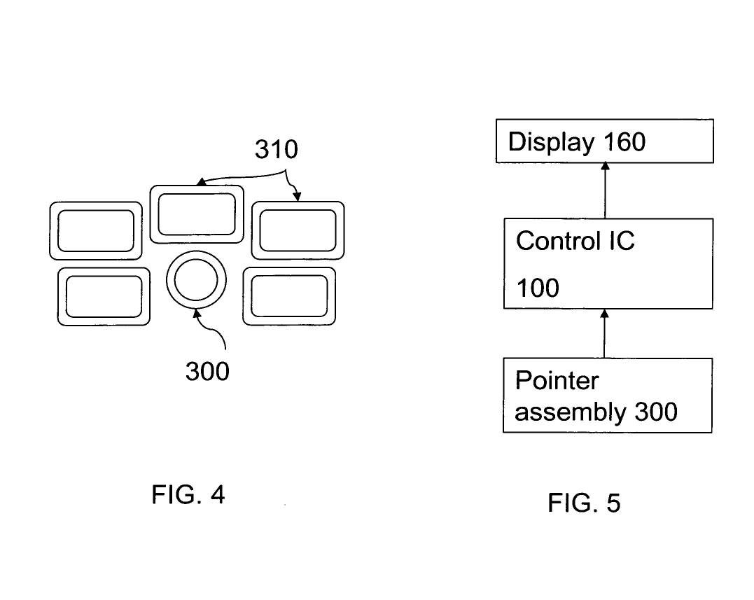

FIGS. 4 and 5 show a diagram of a pointer assembly according to the present invention.

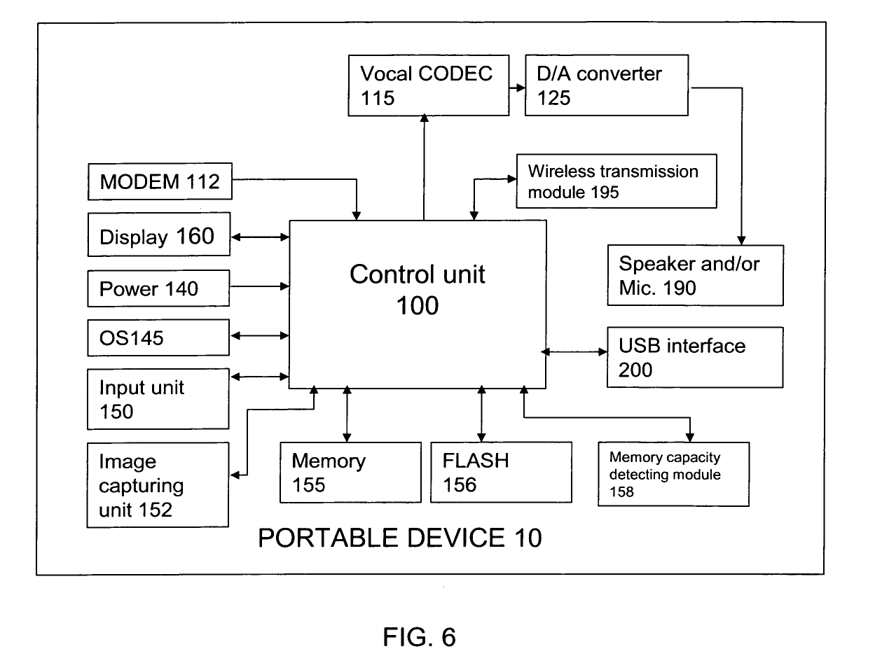

FIG. 6-10 show diagrams of embodiments according to the present invention.

### DETAILED DESCRIPTION

The present invention relates to a portable and hand-held communication device with multi-function. The hand held portable device according to the present invention includes but not limited to cellular, PDA (personal digital assistant), smart phone, media player and the equivalent thereof.

FIG. 1 shows a block diagram of a hybrid portable communication device with SIM card connector 130 to carry the SIM card 135, it is well know in the art, the SIM card is not necessary for some other type of cellular such as PHS system. The diagram is used for illustrating and not used for limiting the scope of the present invention. The portable terminal or device 10 includes a RF module. As know in the art, the RF signal transmission module includes antenna 105. This antenna 105 is connected to a transceiver 110, which is used to receive and transmit signal. AS known, the RF module further includes MODEM 112, CODEC 115, DSP 120 and A/D converter 125 as well. The A/D convert coupled to the speaker is used to converted data between digital and analog as known in the art. The RF module is not the feature of the present invention, therefore, the detailed description is omitted. The present invention includes a central control IC 100, an input unit 150, a build-in display 160, OS 145, power 140 and memory 155 including a ROM program memory, a RAM memory. All of the components are coupled to the Control IC 100. Nonvolatile FLASH memory 156 is coupled to the control IC 100. The RF module may perform the function of signal transmitting and receiving, frequency synthesizing, base-band processing and digital signal processing. The SIM card hardware interface is used for receiving a SIM card. Finally, the signal is send to the final actuators, i.e. a loudspeaker and a microphone 190.

The present invention includes one or more following module that is not disclosed by the current terminal. It should be noted that the additional module can be implanted along or combination depending on the necessary. A data exchange interface 200 is provided and coupled to the control IC 100. The data exchange interface 200 is capable of coupling to the I/O port of an external device such as computer system, directly or indirectly. The data exchange interface 200 provides the interface for exchanging the information between the portable device and the computer system (or the access point). At current, the conventional cell-phone is incapable communicated with the computer system by its built-in unit. The data exchange interface 200 is preferably USB (universal serial bus) interface, Fire Wire interface or the IEEE 1394. The USB or the Fire Wire 200 is provided and coupled to the control IC 100. Through the USB interface or the Fire Wire 200, the user may transfer or update data such as E-mail, MP3 file, image file or downloaded data by employing the control unit of the device. Based above, the control unit of the embodiment may process the MPEG file (audio and/or video file) or e-mail data. Alternatively, the portable device 10 may update information such as OS, program or the like from the computer system. At present, the user can not send the digital picture to the computer directly by the conventional cell-phone device.

Moreover, the element constructed by the USB 200, the flash memory 156 and control IC 100 functions as a flash drive. Therefore, the present invention integrated the cell phone and the flash drive. The present Hybrid Portable Communication Device (HPC) is provided with a plug-in type interface for connecting to the USB (Universal Series Bus) port or the Fire Wire port of the personal computer. A control IC is coupled to the USB or the Fire Wire interface 200. The USB interface is capable of dealing with the USB protocol. The flash memory 156 operates the mode under instruction or command. The operation mode includes read mode, write mode, erase mode, and programming mode. A USB interface 200 is in connection with the controller 100 at one end, thereby creating an electrical connection. A part of the USB or the Fire Wire interface 200 maybe extended outside the housing of the flash drive-like cellular. The inner end of the interface 200 fastened into the inside of the housing. The aforementioned USB interface 200 could be A-type USB interface with a flat and wide shape, or B-type USB interface with a rectangular shape or a Mini-type USB interface with a flat and narrow shape. The definition of USB type may refer to US Patent Application No. 20040038592, entitled “USB flash drive”. The flash memory could be replaced by other NVM (non-volatile memory) such as NROM (nitride-ROM), SONOS or MRAM, FRAM. The present HPC may function as memory drive. The memory drive refers to a commercial memory device with USB interface such as flash drive. As aforementioned, the present invention integrated the cell phone and the flash drive. Furthermore, the device 10 may process the audio or video file, therefore, the device 10 may function as the media player.

In one case, the flash memory 156 can be coupled to the USB or the Fire Wire ports of personal computer, digital camera, etc. by means of the Fire Wire or USB interface 200 which is commercially available products. For the digital camera user, the capacity of the camera's memory card is small. The user has to change the memory card, frequently. One aspect of the present invention is that the digital camera or digital video camera may couple to the flash drive like cellular or called HPC, thereby transferring the data or the image file to the flash memory 156 of the portable device through the USB interface 200. Further, the present invention also includes a wireless transmission module 195 for short distance (range) transmission or transfer between the hand-held device and an external device such as access point or computer (local or remote terminal) via network. The wireless transmission module 195 for short range refers to WLAN (wireless local area network). As known, the WLAN may transfer data, information between the device 10 and the external device. Thus, the device 10 may employ the wireless transmission module 195 to exchange data to replace the function of data exchange interface 200. The wireless transmission module 195 includes 802.11 standard (802.11a, 802.11b, 802.11g, 802.11n), Bluetooth standard or WiMax. In general, the wireless transmission module 195 allows the device 10 couple to the internet via access point, gateway or computer.

Another aspect of the present invention is that a Fire Wire or USB interface releasing unit 210 is provided to release the Fire Wire or the USB interface 200 from the housing of the portable device 10. Please turning to FIG. 2, the USB interface 200 extends from the hosing of the device 10 by pushing or pressing the USB interface releasing unit 210. In one example, the releasing unit 210 is movable from position A to B along a slot 212, indicated by an arrow in the illustration. Alternatively, the interface 200 may be extending by tuning or rotating a holder 500 of the interface. The mechanism is similar to the lip stick holder, as shown in FIG. 3. The interface 200 is held within the holder 500, it is indicates by interface A. After the holder 500 is rotated, the interface 200 is extended out of the holder 500 and is indicated by interface B. Alternatively, the interface 200 may be encapsulated by a cap or ejecting from the housing by an ejecting means.

A further aspect of the present invention includes a memory capacity detecting module 158 coupled to the control IC 100 to detect the capacity of the flash, followed by displaying on the display 160.

FIG. 4 and FIG. 5 illustrate a view of a pointer assembly 30 such as joy stick apparatus or trackball in accordance with preferred embodiments of the present invention. A joy stick member or trackball 300 is mated to a shaft on a keyboard 310. The joystick member 300 may be disposed between keys and coupled to a sensor (not shown). The sensor communicates the signals indicating direction and magnitude of movement to the control IC 100, which in turn controls the movement of a graphical object such as cursor displayed on the display according to information of signals. The pointer assembly is in communication with sensor embedded between keys within a keyboard assembly. As known the pointer assembly is capable of selecting the file or data that is selected by the user. The assembly is helpful to the user to transmit the data between the device and PC via the USB interface (or between the device and the AP via the wireless transmission module 195). Further, the user may use the pointer assembly 30 through the interface 200 to control the object shown on the computer display during playing computer games. For instance, in digital games, the movement of the pointer assembly 300 could move a graphical object of game, such as weapon, person or controlled feature. The sensed signals method or the pointer assembly is described in U.S. Pat. Nos. 5,546,334, 6,091,404, 5,568,987. The references are incorporated for reference.

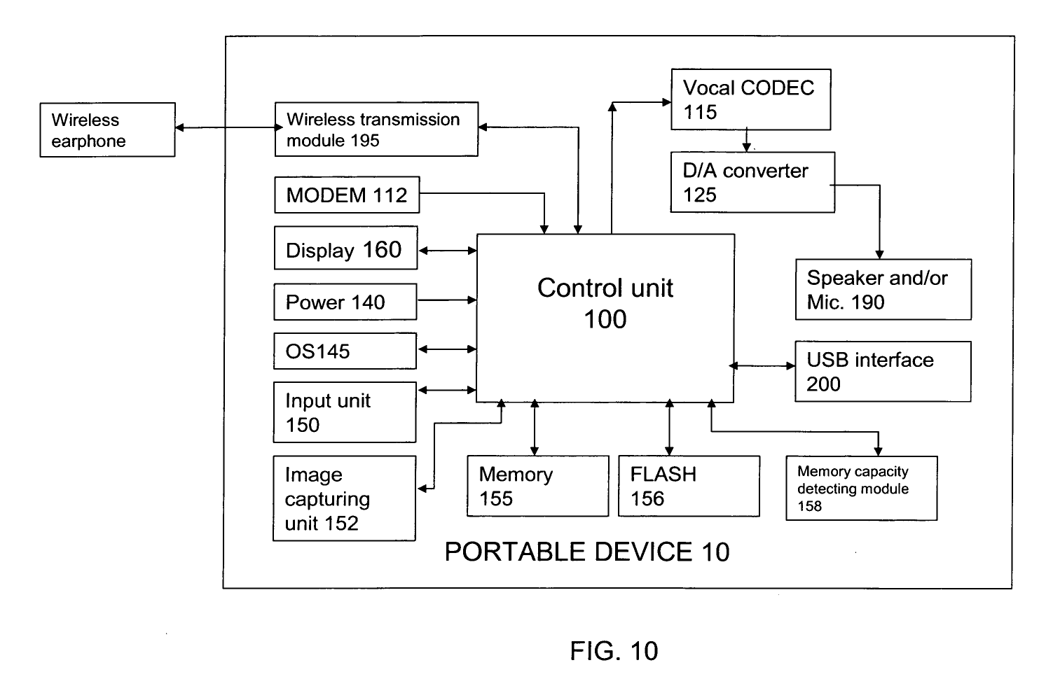

Please refer to the FIG. 6, the embodiment is similar to the FIG. 1 of the base Application 20060143339, filed on Dec. 23, 2004. The embodiment may be performed without the RF communication module, it may omit the antenna 105, transceiver 110 and SIM connector 130 but still includes the vocal CODEC 115, D/A converter 125 coupled between the speaker 190 and the control unit or processing unit 100. As mentioned in the Application 20060143339, the hand held portable device includes the wireless transmission module 195 to allow the device wirelessly exchanges data with an external device (AP or computer). In the above co-pending parent application and the present embodiment, both recite that the control unit may transfer and/or process the MP3 or image file. Therefore, the present invention may employ the control unit 100, wireless transmission module 195 to wireless transfer data with another external device or outside environment, thereby exchanging or updating the information with each other and storing the exchanged video or audio file into the memory 155 or the flash 156. According to the FIG. 1 of Application 20060143339 and the embodiment, the hand-held portable device 10 may wirelessly download, or exchange file through wireless transmission module 195 from an external device or outside environment via the network or other media. Alternatively, the wireless transmission module could be a blue tooth module for communicating with a wireless external device such as wireless earphone as shown in FIG. 10. The user will not be interrupted by the wire during listing the audio file processed by the device 10. The present invention may transfer data between the external device and the present device 10. The external device includes but not limited to an access point, gateway, router, wireless earphone, local or remote computer.

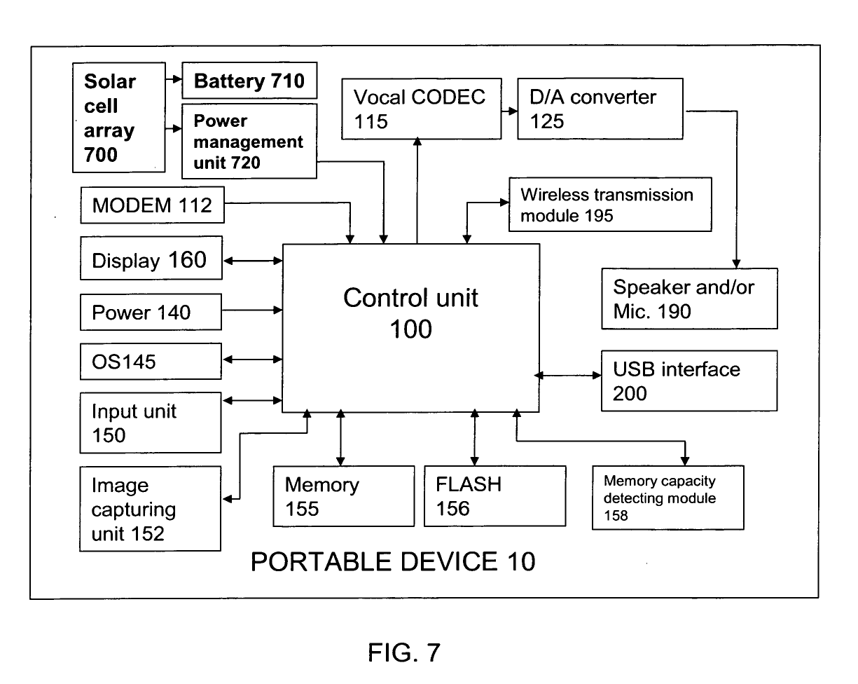

The device in FIG. 6 may couple to external device via the wireless transmission module 195. Thus, the power of the battery may be consumed quickly. In order to compensate the power consumer, the present invention provides a solar cell array 700 to couple and charge to the battery 710 of the device or coupled to the power management unit 720 as shown in FIG. 7. The solar cell array 700 allows the electricity to be charged into the device 10 under charging. The solar cell array (or solar cells) 700 may receive the illumination and therefore generating electricity. The solar cell array (or solar cells) 700 may provide the power to the device 10, directly. Alternatively, the present invention may optionally include a battery 710 to store the electricity generated from the solar cell array 700. In one case, the solar cell array 700 can be attached on the outer surface of the device 10. Alternatively, it could be formed on the surface of the flip cover of the device, or extensible slice from the device to enlarge the surface area.

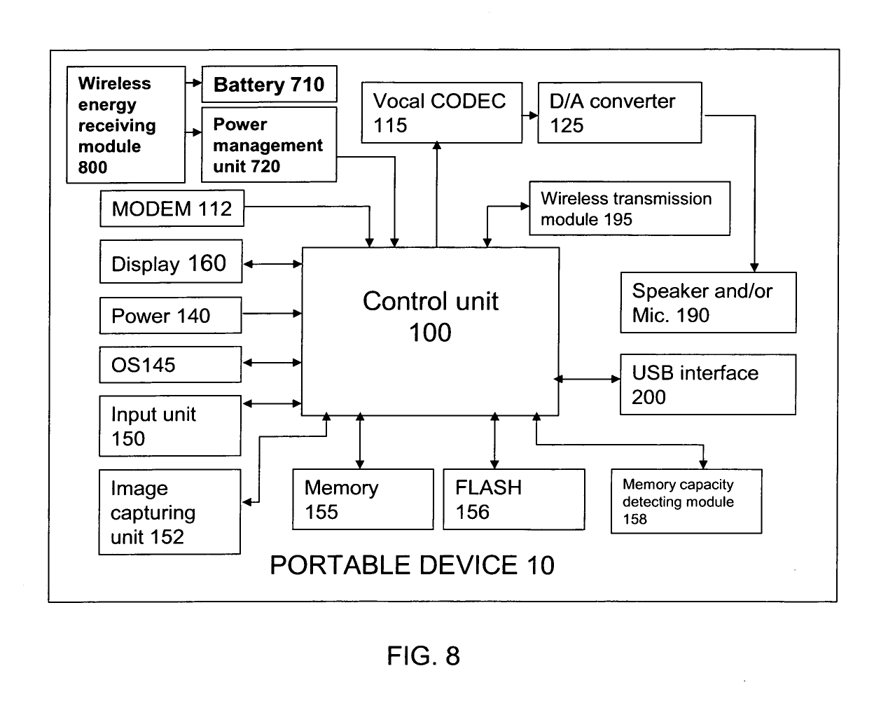

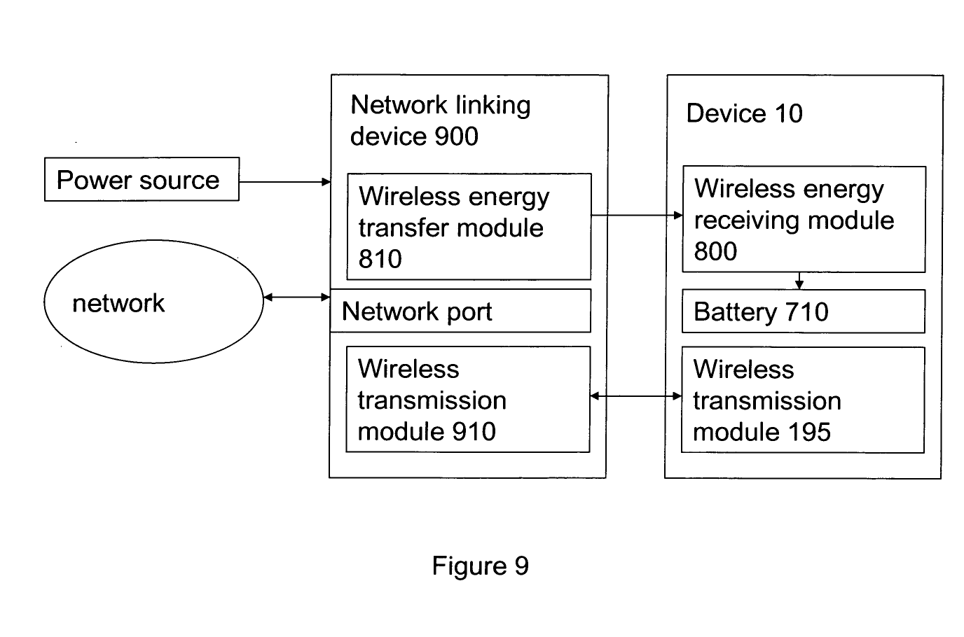

Alternatively, the device 10 includes a wireless energy receiving module 800 to provide a unit for charging the device 10. The wireless energy receiving module 800 may couple to the battery 710 of the device 10 or the power management unit 720 as shown in FIG. 8. An external wireless energy transfer module 810 is provided to transfer energy to the wireless energy receiving module 800 to allow the electricity to be charged into the device 10 under energy transfer. In one case, the wireless energy transfer module 810 may be integrated into the access point or other network linking device 900 such as gateway or router, as shown in FIG. 9. In the embodiment, the network linking device 900 may coupled to power source (or solar cell array, the solar cell may be formed on the surface of the device 900) and connect to the network by network port as known in the art, the description is omitted. The device 900 allows the data exchange between the wireless transmission module 910 and the wireless transmission module 195 of the device 10. In the example, the wireless energy transfer module 810 is embedded in the device 900 to transfer the energy to the wireless energy receiving module 800. The present invention provides a device comprising a processing unit embedded in the device for processing data and a memory coupled to the processing unit to store information. A wireless transmission module is coupled to the processing unit for wireless communication to allow the device couple to an external device and a wireless energy transfer module is coupled to the processing unit for energy transfer. Wireless energy transfer maybe in the form of mutual induction. Using induction it is possible to transmit and receive signals over a range. If resonant coupling is used, power may be transmitted over a range of many meters. A third form of wireless energy transfer is electromagnetic radiation, such as radio waves. Electromagnetic radiation in the form of either radio waves or light can also be used to transfer energy wirelessly. While systems based upon this method are used mostly for information transfer, a high degree of efficiency in power transmission is also achievable under certain circumstances. Researchers at MIT discovered a new way to wirelessly transfer power using non-radiative electromagnetic energy resonant tunneling. If a proper resonant waveguide is brought near the transmitter, the evanescent waves can allow the radio waves to tunnel to the power drawing waveguide, where they can be rectified into DC power. Up five meters of transfer range can be achieved. The method of energy transfer is not the aspect of the present invention. Various methods have been disclosed, and the description is omitted.

As will be understood by persons skilled in the art, the foregoing preferred embodiments of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A hand-held portable device employed to process an audio or video file comprising:
a processing unit embedded in said hand-held portable device;
an input unit and a speaker coupled to said processing unit, respectively;
a memory coupled to said processing unit to store said video or audio file;
a wireless transmission module coupled to said processing unit for wireless communication with an external device to transfer said video or audio file there-between.

2. The hand-held portable device of claim 1, wherein said wireless transmission module includes 802.11x, Bluetooth or WiMax.

3. The hand-held portable device of claim 1, further comprising a solar cell array to provide electrical power.

4. The hand-held portable device of claim 3, wherein a battery of said hand-held portable device is coupled to said solar cell array.

5. The hand-held portable device of claim 3, wherein a power management unit of said hand-held portable device is coupled to said solar cell array.

6. The hand-held portable device of claim 1, further comprising a wireless energy receiving module to receive transferred energy.

7. The hand-held portable device of claim 6, wherein a battery of said hand-held portable device is coupled to said wireless energy receiving module.

8. The hand-held portable device of claim 6, wherein a power management unit of said hand-held portable device is coupled to said wireless energy receiving module.

9. The hand-held portable device of claim 1, further comprising a data exchanging interface coupled to said processing unit, whereby said data exchanging interface may couple to an external device such that said hand-held portable device functions as memory drive.

10. The hand-held portable device of claim 1, further comprising a mobile phone communication module coupled to said processing unit for mobile phone communication.

11. The hand-held portable device of claim 10, wherein said wireless transmission module includes 802.11x, Bluetooth or WiMax.

12. The hand-held portable device of claim 10, further comprising a solar cell array to provide electrical power.

13. The hand-held portable device of claim 12, wherein a battery of said hand-held portable device is coupled to said solar cell array.

14. The hand-held portable device of claim 12, wherein a power management unit of said hand-held portable device is coupled to said solar cell array.

15. The hand-held portable device of claim 12, further comprising a wireless energy receiving module to receive transferred energy.

16. The hand-held portable device of claim 15, wherein a battery of said hand-held portable device is coupled to said wireless energy receiving module.

17. The hand-held portable device of claim 15, wherein a power management unit of said hand-held portable device is coupled to said wireless energy receiving module.

18. The hand-held portable device of claim 1, wherein said external device includes access point, gateway, router, wireless earphone, local or remote computer.

19. A hand-held portable device for processing audio or video data comprising:
a processing unit embedded in said hand-held portable device for processing data;
a memory coupled to said processing unit to store information;
a wireless transmission module coupled to the processing unit for wireless communication to allow said device couple to an external device; and
a wireless energy receiving module coupled to a battery of said hand-held portable device for energy transfer, wherein said wireless energy receiving module receives energy transferred from an external device, wirelessly.

20. The hand-held portable device of claim 19, further comprising a mobile phone communication module coupled to said processing unit for mobile phone communication.

21. A hand-held portable device for processing audio or video data comprising:
a processing unit embedded in said hand-held portable device;
a memory coupled to said processing unit to store information;
a battery embedded in said hand-held portable device; and
a wireless energy receiving module coupled to battery for energy transfer, , wherein said wireless energy receiving module receives energy transferred from an external device, wirelessly.

22. The hand-held portable device of claim 21, further comprising a mobile phone communication module coupled to said processing unit for mobile phone communication.

23. A network linking device comprising:
a processing unit embedded in said network linking device;
a wireless transmission module coupled to the processing unit for wireless communication; and
a wireless energy transfer module coupled to the processing unit for energy transfer.

24. The network linking device of claim 23, wherein said network linking device includes gateway, access point or router.

25. The network linking device of claim 23, wherein said wireless energy transfer module is coupled to power source.

26. The network linking device of claim 23, wherein said wireless energy transfer module is coupled to a solar cell array.
